(19) United States
(12) Patent Application Publication
(10) Pub. No.: US 2023/0136653 A1
(43) Pub. Date: May 4, 2023

(54) LIQUID CRYSTAL CELLS

(71) Applicant: Flexenable Limited, Cambridge (GB)

(72) Inventors: Jan Jongman, Cambridge (GB); Shane Norval, Cambridge (GB)

(21) Appl. No.: 17/913,413

(22) PCT Filed: Mar. 24, 2021
(86) PCT No.: PCT/EP2021/057635

§ 371 Date: Sep. 21, 2022

(30) Foreign Application Priority Data
Mar. 25, 2020 (GB) 2004317.0

(51) Int. Cl. G02F 1/1333; G02F 1/00; G02F 1/1335; G02F 1/1337; G02F 1/1339

(52) U.S. Cl. CPC G02F 1/133305; G02F 1/0045; G02F 1/0063; G02F 1/13396; G02F 1/133377; G02F 1/133514; G02F 1/133711; G02F 2201/123

(57) ABSTRACT

A device comprising a liquid crystal cell, wherein the liquid crystal cell comprises LC material contained between opposing surfaces of two components; wherein the opposing surfaces intermesh in at least one or more regions of the LC cell.

Liquid crystal cells typically comprise liquid crystal material contained between two half-cell components.

The inventors for the present application have conducted research into producing curved liquid crystal cell devices from thin plastics support films. The inventors have noticed incidences of slippage of one half-cell component relative to the other half-cell component, upon bending the liquid crystal cell from a planar, resting configuration into a desired curved configuration.

An aim of the present invention is to better prevent slippage of one half-cell component relative to the other half-cell component.

There is hereby provided a device comprising a liquid crystal cell, wherein the liquid crystal cell comprises LC material contained between opposing surfaces of two components; wherein the opposing surfaces intermesh in at least one or more regions of the LC cell.

According to one embodiment, the opposing surfaces intermesh in at least one or more regions of an active area of the LC cell.

According to one embodiment, the device comprises intermeshing structures defined by patterned layers that also defines spacer structures for the liquid crystal cell.

According to one embodiment, the intermeshing structures also function as spacer structures.

According to one embodiment, at least one of the two components defines an array of colour filters in a black matrix, and at least a portion of the intermeshing structures are located in black matrix regions of the LC cell.

According to one embodiment, the intermeshing structures are selectively located in black matrix regions of the LC cell.

According to one embodiment, the intermeshing structures comprise structures of differing white-light transmittance.

According to one embodiment, the intermeshing structures comprise first structures defined by the one of the two half-cell components and second structures defined by the other of the two half-cell components, and the first spacer structures exhibit greater compressive strain than the second spacer structures.

According to one embodiment, the intermeshing structures comprise first structures defined by a first half-cell component and second structures defined by a second half-cell component; and the dimension in the direction perpendicular to the first and second half-cell components of the second structures is between about 50% and 98% of the dimension in the direction perpendicular to the first and second half-cell components of the first structures.

According to one embodiment, the intermeshing structures comprise first structures defined by a first half-cell component and second structures defined by a second half-cell component; and the first spacer structures and/or the second spacer structures have a cross-sectional area that decreases towards the opposing half-cell component.

According to one embodiment, at least one of the two components defines an array of colour filters, and at least the other of the two components comprises a corresponding array of pixel electrodes; wherein the individual dimension of the colour filters is greater by a first amount than the individual dimension of the pixel electrodes in at least one axis; and wherein the intermeshing of the two components limits the range of relative movement of the two components in the at least one axis by an amount no greater than the first amount.

According to one embodiment, the intermeshing of the two components limits the range of relative movement of the two components to no more than about 20 microns in at least one axis.

There is also hereby provided a method of producing a device as described above comprising: squeezing a controlled volume of the LC material between the two opposing surfaces; wherein the intermeshing structures comprises first structures defined by one of the two half-cell components and second structures defined by the other of the two half-cell components, and wherein the starting height of first spacer structures is greater than the starting height of the second spacer structures.

There is also hereby provided a method of producing a LC cell, comprising: pressing opposing surfaces of first and second half-cell components together; wherein at least one of the opposing surfaces is configured so as to guide the lateral positioning of the opposing surface as the opposing surfaces are pressed together.

According to one embodiment, first spacer structures defined by a first half-cell component are configured to guide the lateral positioning of second spacer structures defined by a second half-cell component, as the opposing surfaces are pressed together.

According to one embodiment, at least the first spacer structures have a cross-sectional area that decreases in a direction towards the opposing surface of the second half-cell component.

According to one embodiment, at least one of the first and second half-cell components defines an array of colour filters, and at least the other of the first and second half-cell components comprises a corresponding array of pixel electrodes; wherein the individual dimension of the colour filters is greater by a first amount than the individual dimension of the pixel electrodes in at least one axis; and wherein the first spacer structures are configured to guide the lateral positioning of the second spacer structures into a final configuration in which the range of relative movement of the first and second half-cell components in the at least one axis is limited by an amount no greater than the first amount.

According to one embodiment, the first spacer structures are configured to guide the lateral positioning of the second spacer structures into a final configuration in which the range of relative movement of the first and second half-cell components is limited to no more than about 20 microns in at least one axis.

According to one embodiment, the method comprises: squeezing a controlled volume of the LC material between the two opposing surfaces before pressing the opposing surfaces together; and wherein the starting height of the first spacer structures is different to the starting height of the second spacer structures.

According to one embodiment, the area density of the first spacer structures may be less than the area density of the second spacer structures.

There is also hereby provided a device comprising a liquid crystal cell, wherein the liquid crystal cell comprises LC material contained between opposing surfaces of two components; wherein at least one of the two components defines first and second sets of spacer structures for the liquid crystal cell; and wherein the first set of the spacer structures exhibit a higher white-light transmittance than the second set of the spacer structures.

According to one embodiment, the first set of spacer structures is defined by one of the two components, and the second set of spacer structures is defined by the other of the two components.

According to one embodiment, the first set of spacer structures have a larger height than the second set of spacer structures.

There is also hereby provided a method of producing a liquid crystal cell, comprising: pressing opposing surfaces of first and second half-cell components together; wherein at least one of the first and second half-cell components defines first and second sets of spacer structures for the liquid crystal cell; and wherein the first set of the spacer structures exhibit a higher white-light transmittance than the second set of the spacer structures.

According to one embodiment, the method comprises producing the first and second sets of spacer structures by a process comprising irradiative cross-linking.

An embodiment of the invention is described in detail hereunder, by way of example only, with reference to the accompanying drawings, in which:

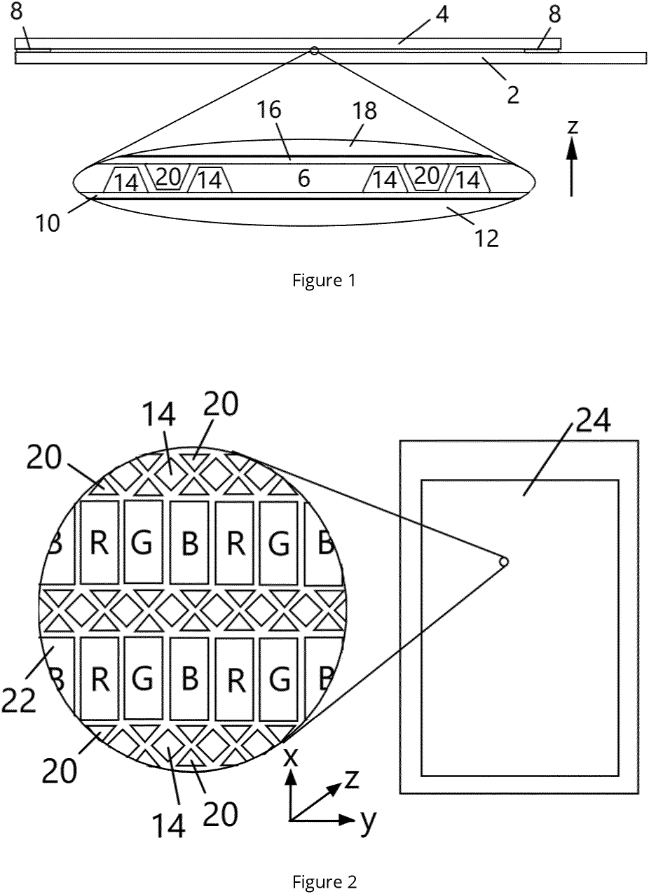

FIG. 1 is a schematic cross-sectional view of a LC cell device according to an embodiment of the present invention;

FIG. 2 is a schematic plan view showing the positional relationship of the intermeshing spacer structures of the device of FIG. 1;

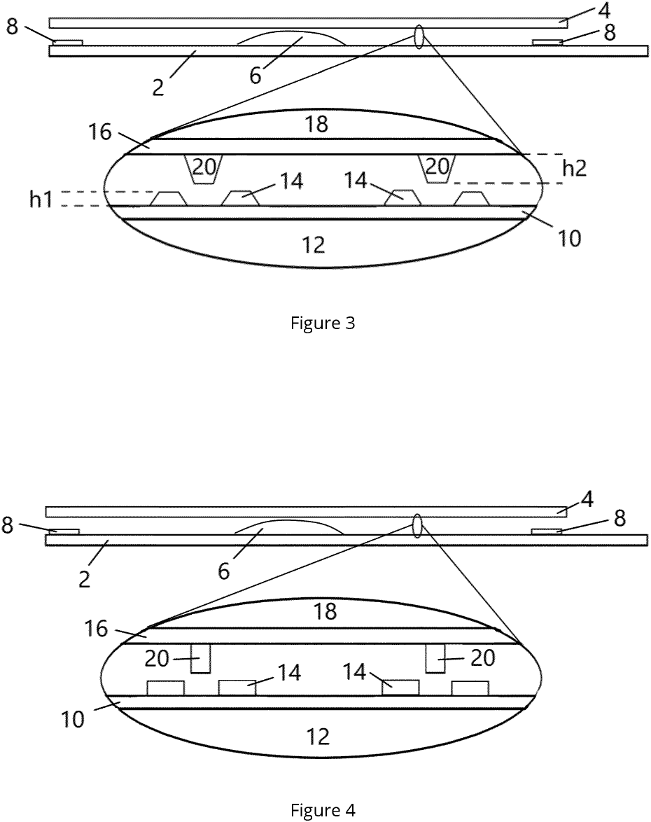

FIG. 3 is a schematic cross-sectional view showing the relative starting heights of the intermeshing spacer structures prior to assembly of the LC cell of the device of FIG. 1;

FIG. 4 shows one example variation for the profile of the spacer structures; and

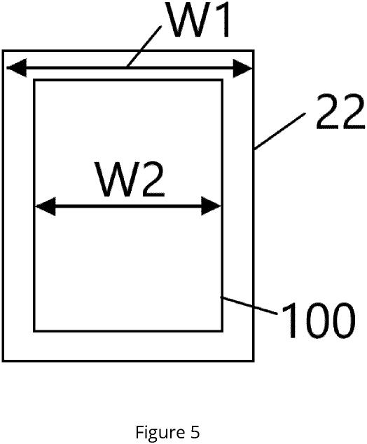

FIG. 5 shows alignment of an example pixel electrode with an example colour filter.

An embodiment is described below for the example of an organic liquid crystal display (OLCD) device, but the technique is also applicable to other kinds of LC cell devices, (including e.g. LC optics devices), particularly other kinds of LC cell devices comprising flexible, thin plastics films as support films . OLCD devices comprise an array of organic thin-film-transistors (OTFTs). OTFTs are characterised by the use of organic semiconductor material (e.g. polymer semiconductors) for the semiconductor channels of the TFTs.

With reference to FIG. 1, the LC cell device comprises LC material 6 contained between two half-cell components 2, 4. The two half-cell components 2, 4 are bonded together by a frame of adhesive material 8. This adhesive material 8 also functions to laterally contain the LC material. The inner perimeter of the frame of adhesive material 8 defines the outer boundary of the active area 24 of the LC cell device.

One of the half-cell components 2 comprises a stack 10 of conductor, semiconductor and insulator layers formed in situ on a plastics support film 12 (such as a thin, optically neutral polymer film such as e.g. a cellulose triacetate (TAC) film). In this example, the stack 10 of conductor, semiconductor and insulator layers defines at least an array of pixel electrodes 100 and active-matrix electrical circuitry for independently controlling the electric potential at each pixel electrode via conductors outside the active area 24. An array of spacer structures 14 is formed in situ on the plastics support film 12 over this stack 10. The spacer structures 14 are formed by forming a layer of patternable material (e.g. a negative photoresist material such as e.g. the epoxy-based negative photoresist material known as SU-8) in situ on the plastics support film 12 over the stack 10, and patterning the layer of patternable material in situ on the plastics support film 12. Finally, a thin LC alignment layer (not shown) is thereafter formed in situ on the plastics support film 12. The LC alignment layer is very thin compared to the height of the spacer structures 14, and does not substantially change the topography of the surface of the half-cell component 2; the surface topography continues to be primarily determined by the spacer structures 14. Alternatively, a layer (e.g. polyimide layer) from which an LC alignment layer may be created (by e.g. a subsequent mechanical rubbing operation or photoalignment operation) is formed in situ on the plastics support film 12 before forming the spacer structures 14, and the afore-mentioned rubbing or photoalignment operation is conducted after forming the spacer structures 14. In either case, the LC alignment layer interfaces the LC material 6 in the regions between the spacer structures. As discussed below, a LC alignment layer is also provided at the surface of the other half-cell component 4, and these two LC alignment layers together control the director of the LC material (molecular orientation of the LC material) for each pixel region in the absence of an overriding electrical field generated by a voltage between a pixel electrode and a counter (COM) electrode. The counter electrode may be on the same side of the LC material 6 as the pixel electrode or on the opposite side of the LC material 6 to the pixel electrode.

The other half-cell component 4 comprises a colour filter array (CFA) 16 formed in situ on a plastics support film 18. The CFA 16 is created by forming and patterning layers of red, green and blue filter material and black matrix material in situ on the plastics support film 18. The CFA 16 defines an array of red, green and blue (RGB) filters 22 in a black matrix. The pitch of the colour filters 22 substantially matches the pitch of the pixel electrodes in both x-y axes of the LC cell. Assembly of the LC cell involves an alignment operation aimed at aligning the centres of the colour filters 22 with the centres of the pixel electrodes 100.

An array of spacer structures 20 is formed in situ on the plastics support film 18 over the CFA. The spacer structures 20 are formed in the same way as the spacer structures for the other half-cell component 2, as described above. An LC alignment layer (not shown) is formed in situ on the plastics support film 18, to interface the LC material 6 in regions between the spacer structures.

As shown in FIGS. 1 and 2, the spacer structures 14 on one of the half-cell components 2 are configured to intermesh with the spacer structures 20 on the other of the half-cell components 4. The spacer structures defined by one half-cell component are configured to fit into spaces between spacer structures defined by the other half-cell component. The intermeshing of the spacer structures 14, 20 limits the extent to which the half-cell components 2, 4 can slip over each other in both x-y axes of the LC cell. In this example, for at least one of the x-y axes, the colour filters 22 have a greater individual dimension (individual width W1 from one edge of a colour filter 22 to the opposite edge of the colour filter 22) than the individual dimension (individual width W2 from one edge of a pixel electrode 100 to the opposite edge of the pixel electrode 100) of the pixel electrodes 100; and the intermeshing of the spacer structures 14, 20 limits the extent to which the half-cell components 2, 4 can slip over each other in either direction of the at least one axis to an amount no more than half the amount by which the individual dimension of the colour filters 22 is wider than that of the pixel electrodes 100. In other words, the intermeshing of the spacer structures limits the total range of relative movement of the two half-cell components in the at least one x-y axis to no more than about the amount by which the individual dimension of the colour filters 22 in the at least one x-y axis is greater than the individual dimension of the pixel electrodes 100 in the at least one x-y axis. In one example, the colour filters 22 have an individual dimension in at least one of the x-y axes (individual width W1 from one edge of a colour filter 22 to the opposite edge of the colour filter 22) that is e.g. about 20 microns greater than the individual dimension of the pixel electrodes 100 in the at least one of the x-y axes (individual width W2 from one edge of the pixel electrode 100 to the opposite edge of the pixel electrode 100); and the intermeshing of the spacer structures limits the extent to which the half-cell components 2, 4 can slip over each other in the at least one of the x-y axes to an amount no more than about 10 microns in either direction away from perfect alignment of the centres of the colour filters and the pixel electrodes in the at least one of the x-y axes) In other words, the intermeshing of the spacer structures limits the total range of relative movement of the two half-cell components 2, 4 in the at least one of the x-y axes to no more than about 20 microns. The extent to which the intermeshing limits the extent of slippage (range of movement) may be different between the x and y axes.

In this example, the spacer structures 14, 20 are tapered in the z-axis to facilitate intermeshing of the spacer structures. The x-y cross-sectional area of each spacer structure decreases in the z-axis away from the plastics support film on which the spacer structures are formed. This tapering may be difficult to achieve with regular patterning (i.e. creating a solubility pattern by UV image exposure and developing the solubility pattern) of some negative photoresist materials. One alternative option is to render the whole of the layer of negative photoresist material insoluble (by e.g. blanket UV exposure), and then pattern the insoluble layer by e.g. dry etching, using a developed positive photoresist pattern as an etching mask, followed by stripping of the positive photoresist etching mask. In another example illustrated in FIG. 4, the spacer structures 14, 20 are not tapered. Each spacer structure has substantially constant x-y cross-sectional area from top to bottom.

As shown in FIG. 2: in this example, the spacer structures 14, 20 for both half-cell components are substantially limited to black matrix regions of the LC cell (i.e. regions of the LC cell occupied by the black matrix of the CFA 16).

As shown in FIG. 3: in this example, the method of producing the spacer structures 14, 20 for the two half-cell components 2, 4 is designed to produce spacer structures for one half-cell component having a starting height (height before cell assembly) that is larger than the starting height of the spacer structures for the other half-cell component (h2>h1 in FIG. 3). This design better facilitates using the volume of LC material 6 to control the average thickness of LC material 6 across the active area 24, while achieving good thickness uniformity of LC material across the active area 24 of the LC cell. In more detail, this use of spacer structures with different starting heights (a) facilitates compression of the LC cell under the action of air pressure on the outsides of the LC cell, in the event that the height of the “tall” spacer structures 20 (within the unavoidable range of process variations (tolerances)) is greater than the average thickness of LC material 6 across the active area 24, while (b) also preventing excessive localised changes in the thickness of the LC material under the “touch” action of a user of the LC cell device. The relatively small total area occupied by “tall” spacer structures 20 that could (within the unavoidable range of process variations (tolerances)) have a starting height greater than the average thickness of LC material 6 across the active area facilitates the compression of those spacer structures (outside the vacuum chamber in which the cell is assembled) under the action of air pressure on the outsides of the LC cell. On the other hand, the greater area occupied by all spacer structures (including the “short” spacer structures 14 and the “tall” spacer structures 20) renders the cell less susceptible to localised compression under the larger forces associated with the “touch” action of a user.

After cell assembly and the return of the assembled to normal pressure conditions outside the assembly chamber, the “tall” spacer structures 20 are compressed by more than the “short” spacer structures 14, and exhibit greater compressive strain (i.e. change in height Δh by compression as fraction of starting height h) than the “short” spacer structures.

According one example embodiment, the starting heights of the spacer structures are configured such that, in the cell after compression and bonding, the “tall” set of the spacer structures (on one half-cell component) contacts the opposing half-cell component, and the other “short” set of spacer structures have a height between about 50% and 98% of the compressed height of the “tall” spacers.

The spacer structure density (fraction of the cell area occupied by spacer structures) for the “tall” spacer structures 20 is calculated taking into account: (i) the Young’s modulus of the spacer structure material for the “tall” spacer structures 20; (ii) the amount by which the height of the “tall” spacer structures 20 might exceed the average thickness of LC material across the active area 24 (within the unavoidable range of process variations).

In one embodiment, the spacer structures defined by one half-cell component have a lower white-light transmittance than the spacer structures defined by other half-cell component. In one example, the “short” spacer structures 14 defined by the half-cell component 2 including the stack 10 comprise carbon black particles dispersed in a polymer material, and the “tall” spacer structures 20 defined by the other half-cell component 4 (including the CFA 16) comprise a polymer material without any light-absorbing particles dispersed therein. This achieves some extra light shielding protection for the underlying organic semiconductor channels, without the light-absorbing material (e.g. carbon black particles) inhibiting UV-initiated deep cross-linking in the deepest photoresist layer (i.e. the photoresist layer to create the “tall” spacer structures 20). In another example, both the “short” spacer structures 14 and the “tall” spacer structures 20 comprise light-absorbing particles (e.g. carbon black particles) dispersed in a polymer material. Another advantage of spacer structures comprising light-absorbing particles (e.g. black spacers) for devices such e.g. privacy screens, is that they facilitate an improvement in the off-state function of the device. The absence of LC material in the regions occupied by spacer structures means that the white-light transmittance of these regions cannot be switched; and using spacer structures comprising light-absorbing particles (e.g. black spacers) reduces white light transmission in these regions.

Forcibly bending the assembled LC cell device from the planar resting configuration (in which it was assembled) into a stressed curved configuration, generates reactive tensile and compressive forces within the plastics support films 12, 18. These internal forces tend to restore those plastics support films 12, 18 to their planar resting configurations. Slippage of one half-cell component relative to the other half-cell component under the action of these internal forces is additionally resisted by the intermeshing interaction of the two half-cell components (in addition to the adhesive strength and cohesive strength of the adhesive material 8 used to bond the two half-cell components 2, 4 together). The intermeshing action of the two half-cell components 2, 4 functions to reduce the shear force acting on the adhesive 8, thereby reducing the risk of failure of the adhesive bond and delamination of the half-cell components. In this example, slippage of one half-cell component relative to the other half-cell component would result in some loss of alignment between the colour filters 22 and the pixel electrodes; and the above-described technique thus serves to reduce the risk of such misalignment.

In the example embodiment described above, the spacer structures 14, 20 are configured to limit slippage substantially equally in both x and y axes. In one example variation, the spacer structures 14, 20 are configured to limit slippage more in (a) the one of the x and y axes that is perpendicular to the intended bending axis (about which the cell is to be forcibly bent) than in (b) the other of the x and y axes. In one example variation, the spacer structures are configured to limit slippage only in the one of the x and y axes that is perpendicular to the intended bending axis (about which the cell is to be forcibly bent).

An embodiment of the invention is described above for the example of a liquid crystal colour display device, but the technique is also applicable to e.g. other liquid crystal cell devices that require maintenance of accurate alignment between the two half-cell components. Other types of liquid crystal cell devices may not comprise all of the elements mentioned above for the example of a liquid crystal colour display device. For example, an LC optics device, such as a LC lens device, may not comprise some elements such as the semiconductor or the CFA.

An example of a technique according to the present invention has been described in detail above with reference to specific process details, but the technique is more widely applicable within the general teaching of the present application. Additionally, and in accordance with the general teaching of the present application, a technique according to the present invention may include additional process steps not described above, and/or omit some of the process steps described above.

In addition to any modifications explicitly mentioned above, it will be evident to a person skilled in the art that various other modifications of the described embodiment may be made within the scope of the invention.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features.

1. A device comprising a liquid crystal (LC) cell, wherein the liquid crystal cell comprises LC material contained between opposing surfaces of two components, wherein the opposing surfaces intermesh in at least one or more regions of the LC cell.

2. The device according to claim 1, wherein the opposing surfaces intermesh in at least one or more regions of an active area of the LC cell.

3. The device according to claim 1, comprising intermeshing structures defined by patterned layers that also defines spacer structures for the liquid crystal cell.

4. The device according to claim 3, wherein the intermeshing structures also function as spacer structures.

5. The device according to claim 3, wherein at least one of the two components defines an array of colour filters in a black matrix, and wherein at least a portion of the intermeshing structures are located in black matrix regions of the LC cell.

6. The device according to claim 5, wherein the intermeshing structures are selectively located in black matrix regions of the LC cell.

7. (canceled)

8. The device according to claim 3, wherein the intermeshing structures comprises first structures defined by the one of the two half-cell components and second structures defined by the other of the two half-cell components, and wherein the first spacer structures exhibit greater compressive strain than the second spacer structures.

9. The device according to claim 3, wherein the intermeshing structures comprise first structures defined by a first half-cell component and second structures defined by a second half-cell component, and wherein the dimension in the direction perpendicular to the first and second half-cell components of the second structures is between about 50% and 98% of the dimension in the direction perpendicular to the first and second half-cell components of the first structures.

10. The device according to claim 1, wherein the intermeshing structures comprise first structures defined by a first half-cell component and second structures defined by a second half-cell component, wherein the first spacer structures and/or the second spacer structures have a cross-sectional area that decreases towards the opposing half-cell component.

11. The device according to claim 1, wherein at least one of the two components defines an array of colour filters, and at least the other of the two components comprises a corresponding array of pixel electrodes, wherein the individual dimension of the colour filters is greater by a first amount than the individual dimension of the pixel electrodes in at least one axis; and wherein the intermeshing of the two components limits the range of relative movement of the two components in the at least one axis by an amount no greater than the first amount.

12. The device according to claim 1, wherein the intermeshing of the two components limits the range of relative movement of the two components to no more than about 20 microns in at least one axis.

13. (canceled)

14. A method of producing a liquid crytal (LC) cell, comprising: pressing opposing surfaces of first and second half-cell components together, wherein at least one of the opposing surfaces is configured so as to guide lateral positioning of the opposing surface as the opposing surfaces are pressed together.

15. The method of claim 14, wherein first spacer structures defined by a first half-cell component are configured to guide the lateral positioning of second spacer structures defined by a second half-cell component, as the opposing surfaces are pressed together.

16. (canceled)

17. The method according to claim 15, wherein at least one of the first and second half-cell components defines an array of colour filters, and at least the other of the first and second half-cell components comprises a corresponding array of pixel electrodes; wherein the individual dimension of the colour filters is greater by a first amount than the individual dimension of the pixel electrodes in at least one axis, and wherein the first spacer structures are configured to guide the lateral positioning of the second spacer structures into a final configuration in which the range of relative movement of the first and second half-cell components in the at least one axis is limited by an amount no greater than the first amount.

18. The method according to claim 15, wherein the first spacer structures are configured to guide the lateral positioning of the second spacer structures into a final configuration in which the range of relative movement of the first and second half-cell components is limited to no more than about 20 microns in at least one axis.

19. The method according to claim 15, comprising: squeezing a controlled volume of LC material between the two opposing surfaces before pressing the opposing surfaces together; and wherein the starting height of the first spacer structures is different to the starting height of the second spacer structures.

20. The method according to claim 13, wherein the area density of the first spacer structures is less than the area density of the second spacer structures.

21. A device comprising a liquid crystal cell, wherein the liquid crystal (LC) cell comprises LC material contained between opposing surfaces of two components; wherein at least one of the two components defines first and second sets of spacer structures for the LC cell, and wherein the first set of the spacer structures exhibit a higher white-light transmittance than the second set of the spacer structures.

22. The device according to claim 21, wherein the first set of spacer structures are defined by one of the two components, and the second set of spacer structures are defined by the other of the two components.

23. The device according to claim 21, wherein the first set of spacer structures have a larger height than the second set of spacer structures.

24. (canceled)

25. (canceled)
